(19) United States
(12) Patent Application Publication
(10) Pub. No.: US 2017/0262975 A1
(43) Pub. Date: Sep. 14, 2017

(54) WAFER INSPECTION METHOD FOR MANUFACTURING SEMICONDUCTOR DEVICE

(71) Applicant: Kabushiki Kaisha Toshiba, Minato-ku (JP)

(72) Inventors: Kazuo FUDEYA, Yokkaichi (JP); Kazuhiro Nojima, Yokkaichi (JP)

(73) Assignee: Kabushiki Kaisha Toshiba, Minato-ku (JP)

(21) Appl. No.: 15/266,168

(22) Filed: Sep. 15, 2016

Related U.S. Application Data
(60) Provisional application No. 62/304,972, filed on Mar. 8, 2016.

(51) Int. Cl. G06T 7/00

(52) U.S. Cl. CPC G06T 7/0008; G06T 2207/30148; G06T 2207/30204

(57) ABSTRACT

A wafer inspection method includes providing a wafer with at least one position marker; setting a care area around the at least one position marker; detecting a plurality of defects in the wafer by using a surface inspection apparatus identifying the at least one position marker as a defect, the plurality of defects including the defect corresponding to the at least one position marker; and achieving an off-set value of coordinates of the plurality of defects based on the coordinates of the defect corresponding to the at least one position marker and the coordinates of the at least one position marker.

### CROSS-REFERENCE TO RELATED APPLICATIONS

This application is based upon and claims the benefit of priority from U.S. Provisional Patent Application 62/304,972 filed on Mar. 8, 2016; the entire contents of which are incorporated herein by reference.

### FIELD

Embodiments are generally related to a wafer inspection method for manufacturing a semiconductor device.

### BACKGROUND

In-line inspection of wafers in the manufacturing process is essential for improving the manufacturing yield of semiconductor devices. As the integration degree advances in integrated circuits and memory devices, however, it becomes difficult to assign a defect detected by the in-line inspection to a structure element. The major reason of this is in the accuracy of defect position that includes deviations due to the unintentional shift of coordinates and measurement error induced in each inspection and that is relatively lowered as the miniaturization of device structure advances.

### BRIEF DESCRIPTION OF THE DRAWINGS

FIG. 1 is a flowchart showing a wafer inspection method according to a first embodiment;

FIGS. 2A to 2C are schematic views showing arrangements, as examples, of position markers according to the first embodiment;

FIG. 3 is a schematic view showing the marker pattern according to the first embodiment;

FIG. 4 is a schematic view showing a configuration, as an example, of the marker pattern according to the first embodiment;

FIGS. 5A and 5B are schematic views showing another marker pattern according to the first embodiment;

FIG. 6 is a table showing layer arrangements of the marker pattern according to the first embodiment;

FIGS. 7A and 7B are schematic views showing a position marker according to a variation of the first embodiment;

FIG. 8 is a flowchart showing a wafer inspection method according to the variation of the first embodiment;

FIGS. 9A to 11B are schematic views showing the wafer inspection method according to the variation of the first embodiment;

FIGS. 12A to 14B are schematic views showing a wafer inspection method according to a second embodiment;

FIG. 15 is a schematic view showing a scanning way in the wafer inspection according to the second embodiment;

FIG. 16 is a flowchart showing a wafer inspection method according to a third embodiment; and

FIG. 17 is a schematic view showing a method of assigning a marker position according to the third embodiment.

### DETAILED DESCRIPTION

According to an embodiment, a wafer inspection method includes providing a wafer with at least one position marker; setting a care area around the at least one position marker; detecting a plurality of defects in the wafer by using a surface inspection apparatus identifying the at least one position marker as a defect, the plurality of defects including the defect corresponding to the at least one position marker; and achieving an off-set value of coordinates of the plurality of defects based on the coordinates of the defect corresponding to the at least one position marker and the coordinates of the at least one position marker.

Embodiments will now be described with reference to the drawings. The same portions inside the drawings are marked with the same numerals; a detailed description is omitted as appropriate; and the different portions are described. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

There are cases where the dispositions of the components are described using the directions of XYZ axes shown in the drawings. The X-axis, the Y-axis, and the Z-axis are orthogonal to each other. Hereinbelow, the directions of the X-axis, the Y-axis, and the Z-axis are described as an X-direction, a Y-direction, and a Z-direction. Also, there are cases where the Z-direction is described as upward and the direction opposite to the Z-direction is described as downward.

### First Embodiment

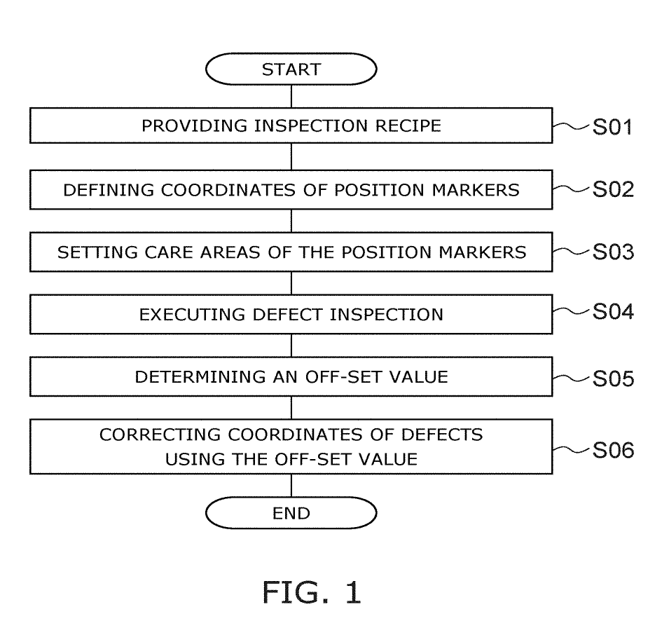

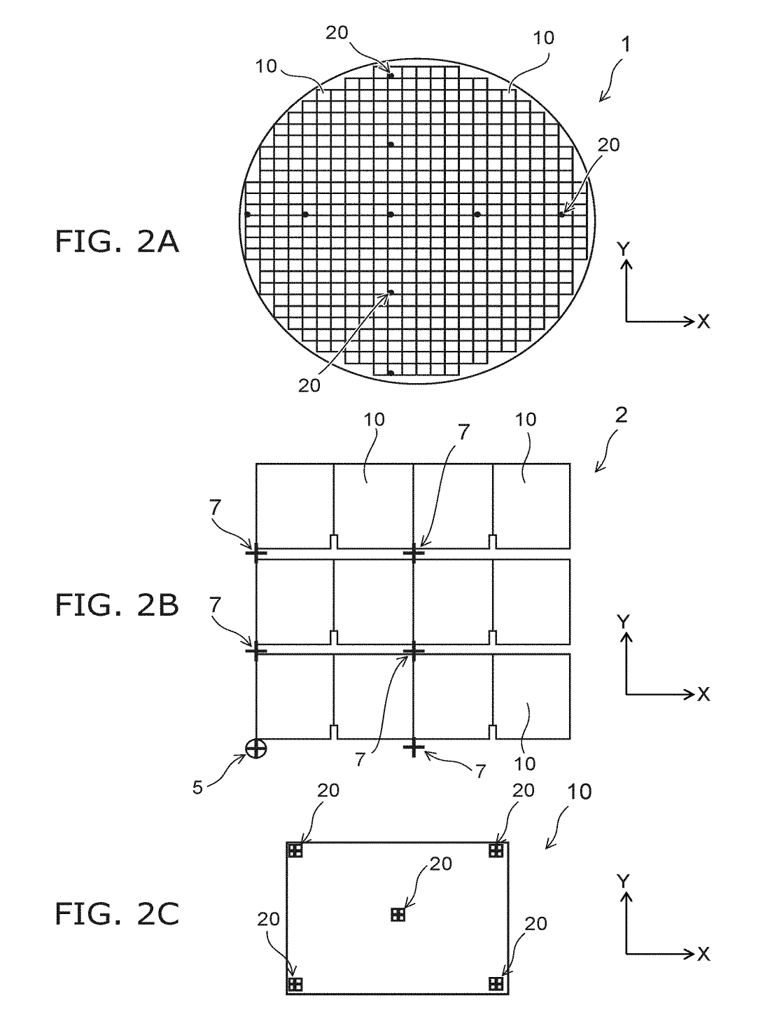

FIG. 1 is a flow chart showing a wafer inspection method according to a first embodiment. The wafer 1 used for the inspection includes e.g. chip patterns 10 and position markers 20. FIGS. 2A to 2C are schematic views illustrating the arrangement of the position markers 20 according to the first embodiment.

The wafer 1 shown in FIG. 2A includes a plurality of position markers 20 on its surface. The position markers 20 are recognized as surface defects in e.g. a SEM (scanning electron microscope) or optical wafer inspection apparatus (not shown). The procedure of the wafer inspection is now described with reference to FIG. 1.

Step S01: Setting an inspection recipe. For instance, the controller of the inspection apparatus retrieves the design information of the semiconductor chip from a database, and sets e.g. a wafer size, and a repetition pitch and placement of chip patterns 10 formed on the wafer.

Step S02: Setting coordinates of position markers 20. The position marker 20 is placed at e.g. coordinates assigning a particular position on the wafer. Alternatively, the position marker 20 may be placed at coordinates specifying a relative position with respect to the chip pattern 10.

For instance, the position markers 20 are placed on the wafer with a pitch different from that of the chip patterns 10. The position marker 20 is placed in e.g. one of two adjacent chip patterns 10. That is, the position marker 20 is recognized as a surface defect in the surface inspection comparing two adjacent chip patterns 10.

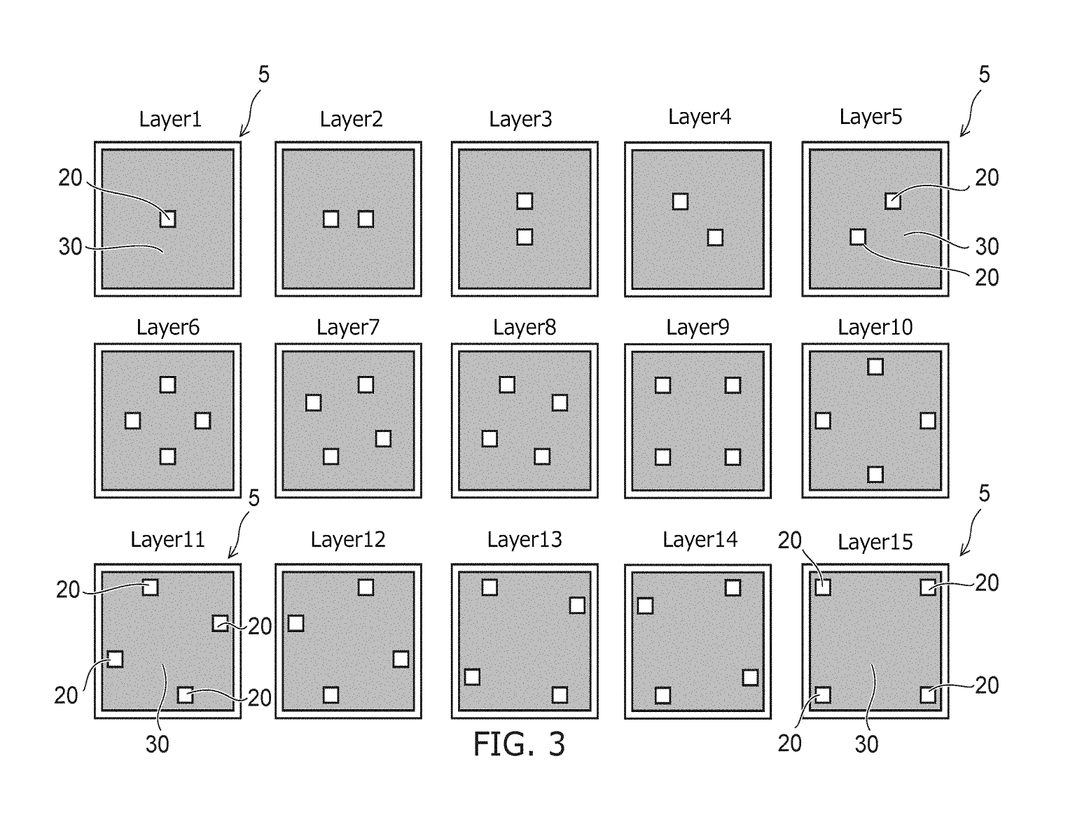

Step S03: Setting care areas 30 (see FIG. 3) around the position markers 20. The care area 30 is a region to be searched for the presence or absence of defects in e.g. the process for detecting surface defects corresponding to the position markers 20. The care area 30 is set so that the surface defects corresponding to the position markers 20 are placed inside the care area 30 in view of the shift amount of coordinates and measurement error in each inspection.

The care area 30 has preferably a size fitted, for example, to the viewing field of the inspection apparatus. Furthermore, preferably, the care area 30 does not include all or part of the elements of the chip pattern 10. That is, the care area 30 is set so as not to include the defects other than the surface defects corresponding to the position markers 20. This makes it easier to detect the surface defects corresponding to the position markers 20.

Step S04: Scanning the surface of the wafer 1 to detect surface defects. For instance, the SEM images, the bright-field images, or the dark-field images of two adjacent chip patterns 10 are compared. The presence or absence of defects is determined based on the difference of signal intensity exceeding a preset threshold, and then, the coordinates of the defects (in the inspection coordinate system) are recorded. Here, the inspection coordinates are identified by the inspection apparatus. For instance, the inspection coordinates include off-set of the inspection apparatus or in each inspection.

Step S05: Extracting the off-set value. For instance, the coordinates of the surface defects corresponding to the position markers 20 (in the inspection coordinate system) are extracted from the inspection data. The distance between the coordinates of the surface defects (in the inspection coordinate system) and the coordinate of the position marker 20 (in the reference coordinate system) is calculated as the off-set value of the inspection data. The off-set value is calculated as the mean value of the distance between a plurality of position markers 20 provided on the surface of the wafer 1 and the corresponding surface defects, or the median or mode value in the distance distribution. Here, the reference coordinate system is, for example, a coordinate assigned on the wafer, or the design coordinate.

Step S06: Correcting the coordinates of the defects. The coordinates of the defects other than the surface defects corresponding to the position markers 20 are corrected using the off-set value detected in step S05.

In the embodiment, the surface defects corresponding to the position markers 20 are detected in the process of surface inspection of the wafer. Thus, the off-set value in each inspection can be determined through the process of data processing in the surface inspection apparatus, or data processing using the inspection results stored in a database.

Then, the off-set value is used to correct the coordinates of the defects other than the surface defects corresponding to the position markers 20. The accuracy of defect position may be improved through this process.

FIGS. 2B and 2C are schematic views showing another arrangement of position markers 20 as example. FIG. 2B shows e.g. the arrangement of chip patterns 10 in a reticle 2 used for the photolithography. FIG. 2C shows chip patterns 10 with the position markers 20 placed therein.

As shown in FIG. 2B, the reticle 2 includes a plurality of chip patterns 10, a marker pattern 5, and marker patterns 7. The marker pattern 5 includes position markers 20 in a care area 30 (see FIG. 3). The marker pattern 7 includes no position markers 20, but includes a pattern corresponding to the care area 30. The reticle 2 includes e.g. one marker pattern 5 and a plurality of marker patterns 7. The marker patterns 5 and 7 are placed respectively at a position close to each chip pattern 10, or inside the chip pattern 10. For instance, the marker patterns 5 and 7 are placed respectively between adjacent chip patterns 10.

The marker patterns 5 and 7 are placed respectively so that the relative position thereof with respect to each chip pattern 10 is the same as other chip pattern 10. In the case where the marker 5 or 7 is placed in the chip pattern 10, the marker 5 or 7 is placed so that the position of marker 5 or 7 in each chip pattern 10 is the same as that in other chip pattern 10. Thus, the surface inspection apparatus may recognize the position marker 20 as a defect, which is included in the marker pattern 5.

As shown in FIG. 2C, a plurality of position markers 20 may be placed inside the chip pattern 10. However, the position marker 20 is not provided in other chip patterns 10 adjacent thereto in the X-direction and the Y-direction.

In the example shown in FIG. 2B, the position marker 20 is placed at a position close to a prescribed chip pattern 10. The position thereof is defined as the relative position with respect to the chip pattern 10. In the example shown in FIG. 2C, the position marker 20 is placed in the chip pattern 10. The coordinates of the position marker 20 may be identified by assigning the position of the prescribed chip pattern 10, or the position of the chip pattern 10 including the position marker 20, in the plane of the wafer 1.

FIG. 3 is a schematic view showing marker patterns 5 according to the first embodiment. Each marker pattern 5 includes a pattern corresponding to the position marker 20. Layers 1 to 15 shown in FIG. 3 are the names representing mask layers sequentially used for lithography. The marker patterns 5 are provided in the mask layers respectively. The marker patterns 5 are provided e.g. in the region corresponding to the position shown in FIGS. 2A to 2C at which the position marker 20 is arranged.

In the following description, it is assumed for convenience that the marker pattern 5 includes at least one position marker 20 and a care area 30 therearound. The marker pattern 5 of Layer 1 includes one position marker 20. The marker patterns 5 of Layers 2-5 each include two position markers 20. The marker patterns 5 of Layers 6-15 each include four position markers 20. In the data processing procedure described later, the distance between the position markers 20 is used, which is defined along a line passing through the geometric barycenter of the four position markers 20 in each of the layers 6 to 15. Then, a distance between one pair of positon markers 20 is equal to a distance between the other pair of position markers 20.

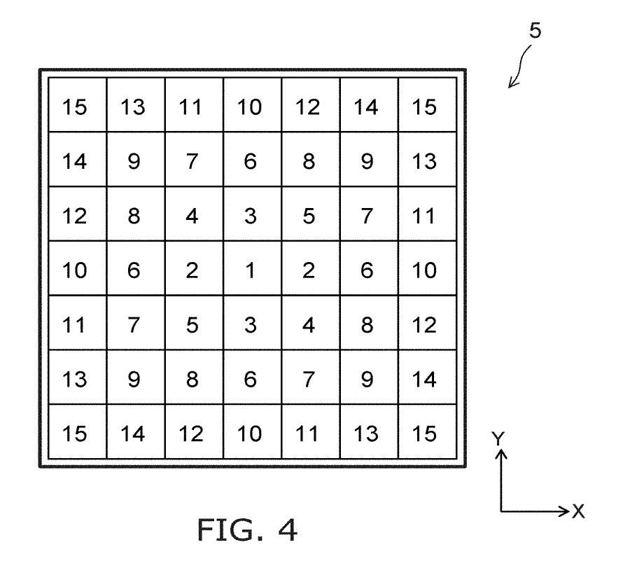

FIG. 4 is a schematic view illustrating an arrangement, as an example, of position markers 20 in the marker pattern 5. The position markers 20 are disposed respectively in regions divided by a lattice like boundary as shown in FIG. 4. The numeral denoted in FIG. 4 corresponds to the name of mask layer. A position marker 20 of each mask layer is placed in the region denoted with the corresponding numeral.

As shown in FIG. 4, the position markers 20 are placed so as not to overlap each other in the marker pattern 5. This makes it easy to detect surface defects corresponding to the position markers 20 of each layer.

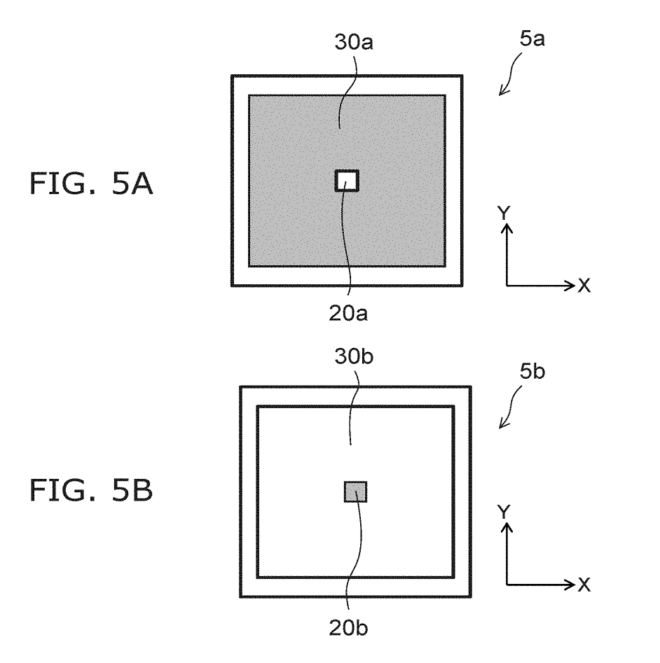

FIGS. 5A and 5B are schematic views showing other marker patterns 5a and 5b respectively according to the first embodiment.

As shown in FIG. 5A, the marker pattern 5a includes a position marker 20a and a care area 30a. The position marker 20a is transparent for exposure light. The care area 30a blocks the exposure light. For instance, when forming an opening corresponding to the position marker 20 in the resist on the wafer, the marker pattern 5a is so called a positive pattern.

As shown in FIG. 5B, the marker pattern 5b includes a position marker 20b and a care area 30b. The position marker 20b blocks the exposure light. The care area 30b is transparent for exposure light. For instance, when the resist corresponding to the position marker 20 is left on the wafer, the marker pattern 5b is so called a negative pattern.

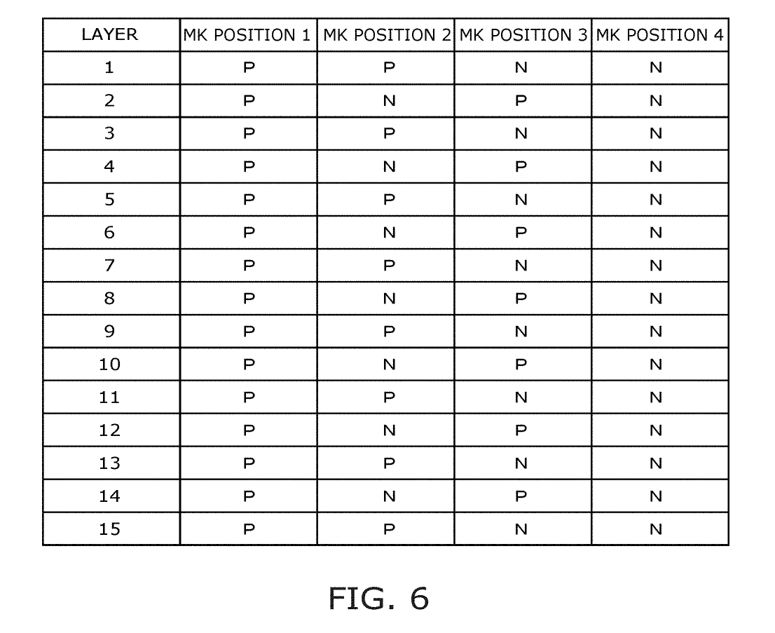

FIG. 6 is a table showing an interlayer arrangement of marker patterns 5 according to the first embodiment. Marker positions (MK positions) 1 to 4 shown in FIG. 6 represent coordinates different from each other on the surface of the wafer 1. “P” in FIG. 6 represents the positive pattern. “N” in FIG. 6 represents the negative pattern.

As shown in FIG. 6, a marker pattern 5 placed at the marker position 1 is of the positive type in all Layers 1 to 15. On the other hand, a marker pattern 5 placed at the marker position 4 is of the negative type in all Layers 1 to 15. The marker patterns 5 of the positive type and the negative type are used alternately in the marker positions 2 and 3.

Thus, position markers 20 with different structures can be simultaneously formed at the marker positions 1 to 4 by appropriately using the positive-type marker pattern or the negative-type marker pattern. It is possible to achieve desired detection sensitivity over the inspection apparatuses of different types. For instance, the desired detection sensitivity may be obtained at the position marker 20 of each of Layers 1-15 for at least one of the SEM image, the bright-field image, and the dark-field image.

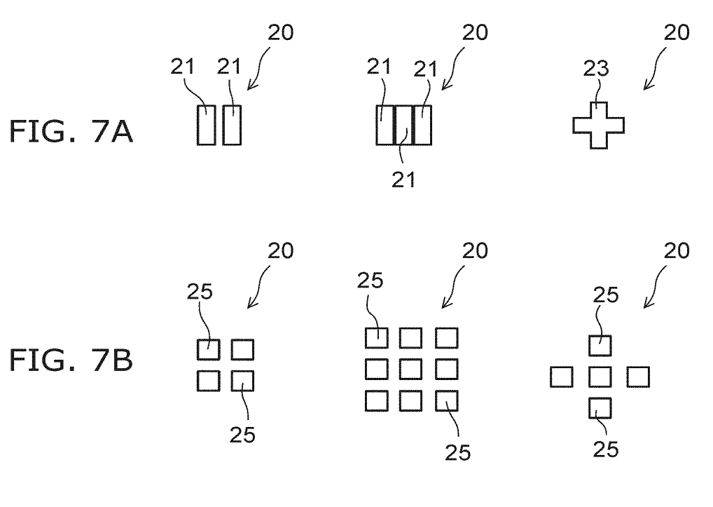

FIGS. 7A and 7B are schematic views showing position markers 20 according to variations of the first embodiment.

As shown in FIG. 7A, the position marker 20 may include e.g. a plurality of rectangular sub-patterns 21. Alternatively, as shown in FIG. 7A, the position marker 20 may be a cross pattern 23. Such a position marker 20 is suitable e.g. for the process of forming interconnects of the semiconductor device.

As shown in FIG. 7B, the position marker 20 may include e.g. a plurality of square sub-patterns 25. Alternatively, as shown in FIG. 7B, the position marker 20 may include sub-patterns 25 arranged in a cross-like shape. Such a position marker 20 is suitable e.g. for the process of forming a contact holes.

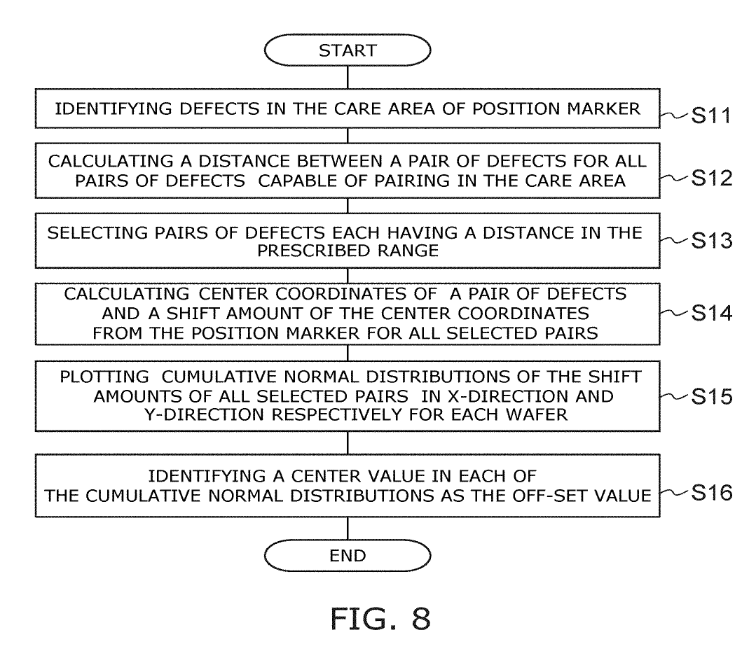

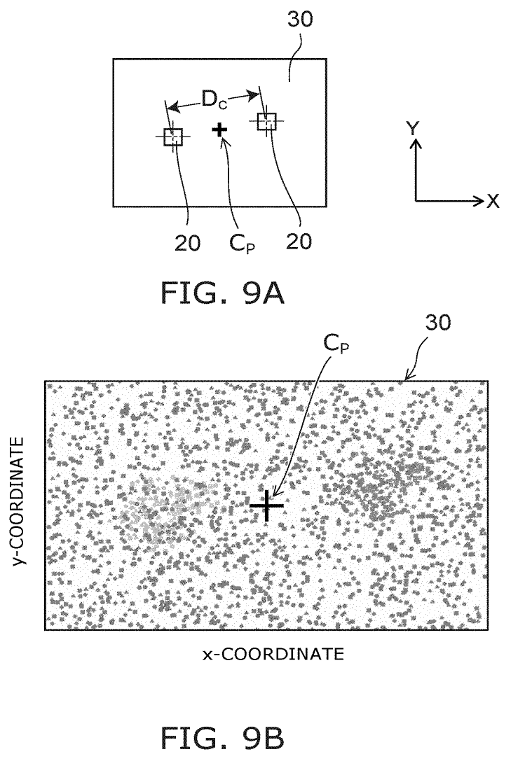

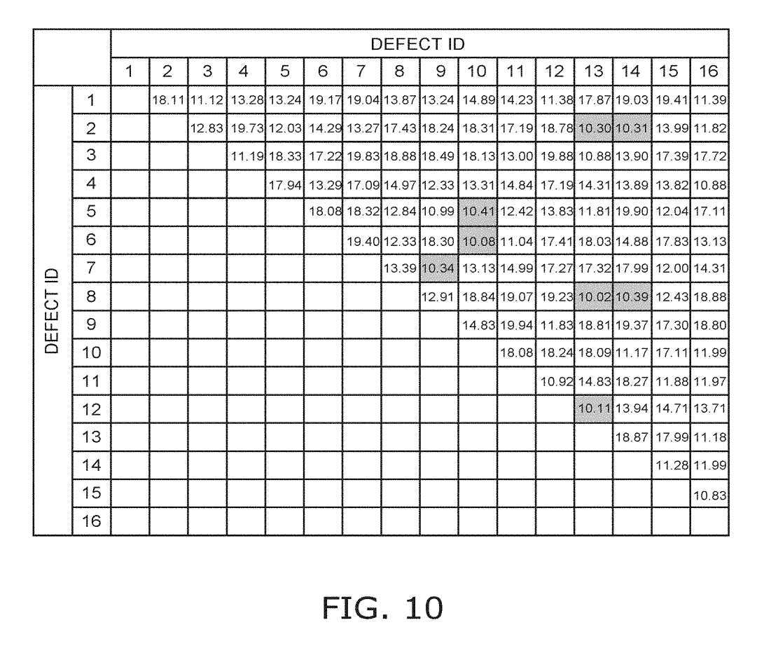

Then, a wafer inspection method according to a variation of the first embodiment is described with reference to FIGS. 8 and FIGS. 9A to 11B. FIG. 8 is a flow chart showing a method for detecting an off-set value according to the variation of the first embodiment. FIGS. 9A to 11B are schematic views showing the process for detecting the off-set.

The method for detecting the off-set value is now described with reference to the flow chart shown in FIG. 8.

Step S11: Detecting a defect located in the care area 30. For instance, FIG. 9A is a schematic view showing position markers 20 and a care area 30. In this example, two position markers 20 are placed in the care area 30. The distance between the centers of the position markers 20 is denoted by Dc. Cp in FIG. 9A is the geometric barycenter of the position markers 20. That is, Cp is the midpoint of the line connecting the centers of the position markers 20.

FIG. 9B is a schematic view illustrating defects located in the care area 30. For instance, the defect positions are assigned using the coordinates with reference to the chip pattern 10 that includes the position markers 20 or that is adjacent to the position markers 20. FIG. 9B is a schematic view illustrated by superimposing defects located in a plurality of care areas 30 defined on the wafer.

Step S12: Calculating the distance between a pair of defects for all pairs detected in the care area 30. For instance, FIG. 10 is a distance map showing distances of all pairs located in the care area 30. A distance between a pair of defects is e.g. a distance between one defect coordinates and the other defect coordinates.

Step S13: Selecting pairs of defects having a prescribed distance. For instance, all pairs of defects each having a distance in the range of Dc±Δd are selected. In the example shown in FIG. 10, Dc is equal to 10 micrometers. Thus, all pairs of defects having a distance in the range of 10±0.5 micrometers are selected.

Step S14: Calculating the differences in the X-coordinate and the Y-coordinate respectively between the center coordinates of the selected pair of defects and the coordinates of the center Cp of the position markers 20.

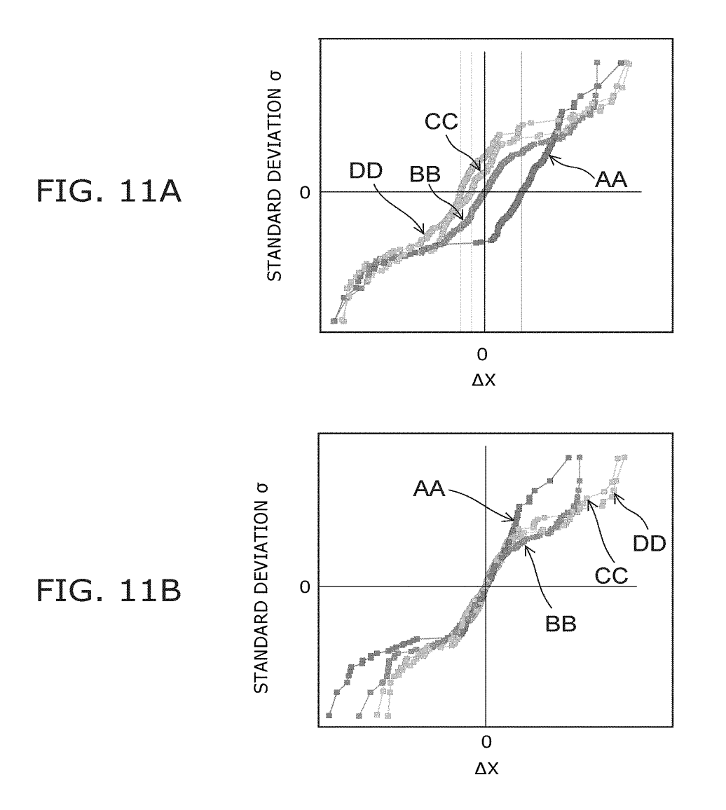

Step S15: Plotting the cumulative normal probability distribution of the distance between the center of the pair of defects and Cp. For instance, FIG. 11A is a graph showing the cumulative normal probability distribution plotted with respect to the difference ΔX in X-coordinate between the center of the pair of defects and Cp. FIG. 11A shows the cumulative normal probability distributions of four wafers AA, BB, CC, and DD. The horizontal axis represents ΔX. The vertical axis represents the standard deviation σ.

Step S16: Extracting the value of ΔX at the center of the cumulative normal probability distribution as an off-set value of X-coordinate. An off-set value in the Y-direction is similarly extracted from the cumulative normal probability distribution of the difference in the Y-coordinate between the center of the pair of defects and Cp. FIG. 11B shows a cumulative normal probability distribution after the correction of defect coordinates using the off-set value.

In this example, using the distance Dc between two position markers 20, the defect coordinates corresponding to the position marker 20 are identified, and then, the off-set value of the defect coordinates is obtained. Thus, the off-set value can be achieved even in the case where the care area 30 includes defects other than the surface defects corresponding to the position markers 20. This may improve the positional accuracy of the defects.

### Second Embodiment

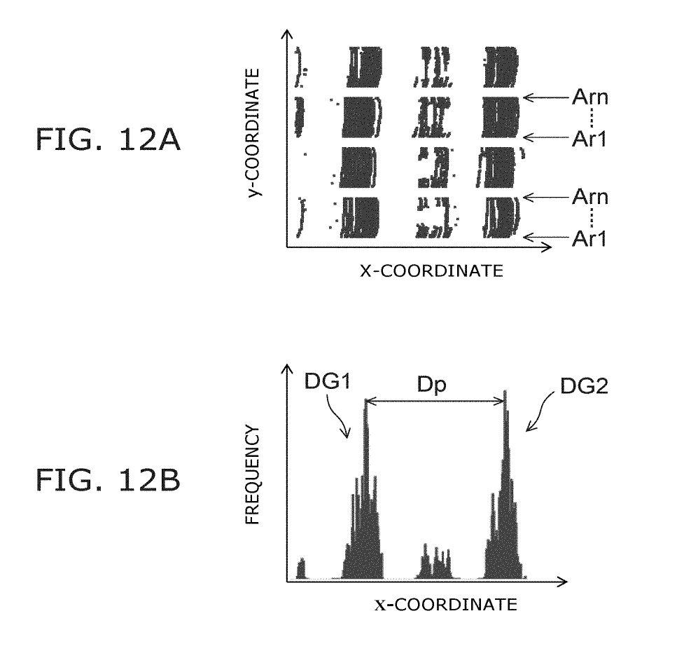

Then, a wafer inspection method according to a second embodiment is described with reference to FIGS. 12A to 14B. FIGS. 12A to 14B are schematic views showing a procedure of data processing in the wafer inspection according to the second embodiment.

The embodiment provides e.g. a method for identifying defect coordinates in the chip pattern 10 without using the position marker 20. For instance, FIG. 12A is an inspection result showing the distribution of defects in a chip pattern of a semiconductor memory device. The vertical axis and the horizontal axis represent the coordinate axes of the chip pattern. FIG. 12A is the result of the inspections using a plurality of wafers which includes data obtained using a plurality of surface inspection apparatuses.

FIG. 12B is a histogram showing the distribution of the X-coordinates of the defects shown in FIG. 12A. FIG. 12B includes the data of the defects corresponding to memory cell arrays Ar1-Arn arranged in the Y-direction. FIG. 12B includes two defect groups DG1 and DG2. The peaks of the respective distributions are spaced by a distance Dp.

For instance, the pairs having a distance in the X-direction in the range of Dp±Δd are selected (see FIG. 10) from all pairs obtained by paring one defect included in the defect group DG1 and the other defect included in the defect group DG2. Next, the cumulative normal probability distribution of the difference ΔX between the center of each selected pair and the midpoint of the peak positions of the defect groups DG1 and DG2 is plotted for each wafer (see FIG. 11A). Then, the value of ΔX corresponding to the median of the cumulative normal probability distribution of each wafer is used as an off-set value to correct the defect coordinates of the wafer (see FIG. 11B).

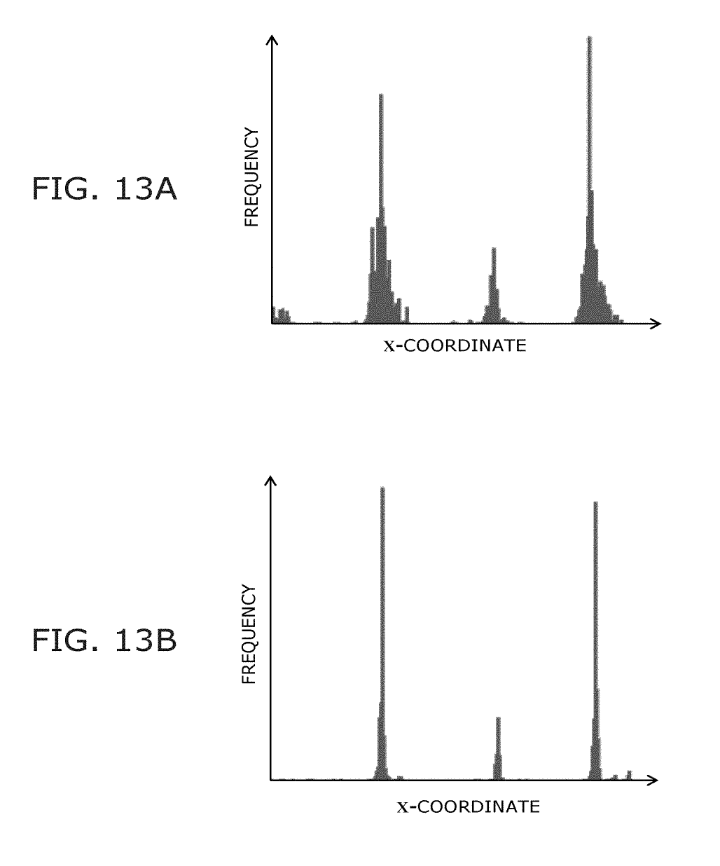

FIG. 13A is a histogram of the X-coordinates showing the defect distribution after the correction of defect coordinates for each wafer. It is found that the deviation of defect positions is suppressed, and the accuracy of the defect positions is improved. The embodiment is not limited to the example above. For instance, the distance Dp between the peaks of the defect groups DG1 and DG2 may be replaced by the distance between specific patterns in which the defects are induced. The cumulative normal probability distribution may be plotted based on the difference between the coordinates of the specific pattern and the coordinates of each selected pair.

Furthermore, the cumulative probability distribution is plotted for each chip pattern included in each wafer. The off-set value of X-coordinate in each chip pattern is achieved similarly. Then, the defect coordinate is corrected using each off-set value in each chip pattern. FIG. 13B is a histogram showing the X-coordinates of the defects after the correction of coordinates for each chip pattern.

Furthermore, the cumulative probability distribution is plotted for each memory cell array included in each chip pattern. Each off-set value of X-coordinate in memory cell arrays

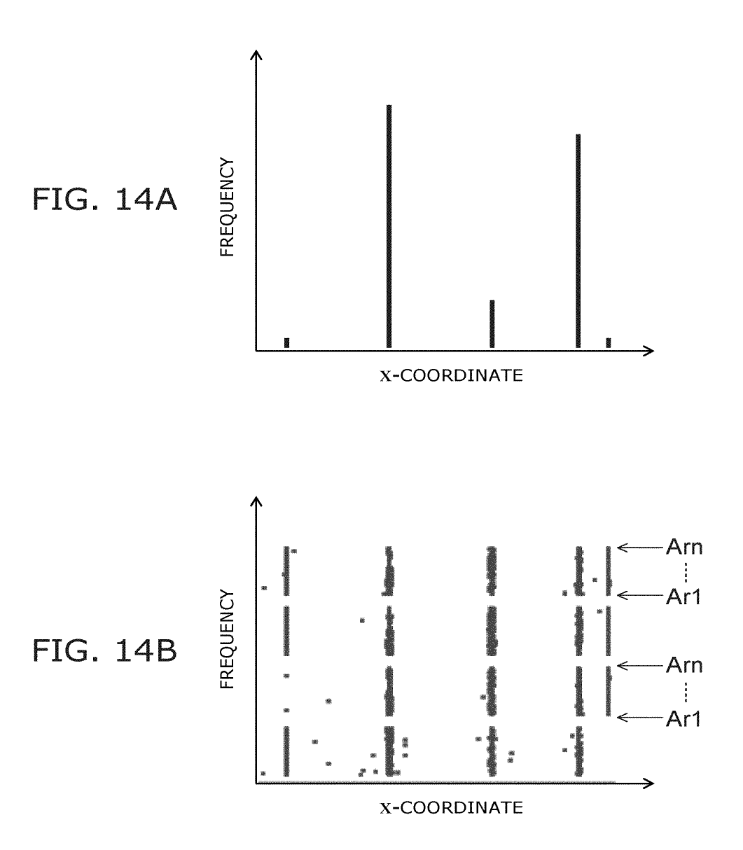

Ar1-Arn is achieved similarly. Then, the defect coordinates is corrected using each off-set value in each memory cell array. FIG. 14A is a histogram showing the X-coordinates of the defects after the correction of coordinates for each memory cell array.

FIG. 14B is a schematic view showing the distribution of defects after the aforementioned correction. As shown in FIG. 14B, the accuracy of relative position is significantly improved in the X-coordinates of the defects. Each defect is distributed linearly in the Y-direction. This indicates that each defect corresponds e.g. to a component extending in the Y-direction of the chip pattern. The component corresponding to the defects may be identified based on the distance in the X-direction between the defect groups.

The embodiment has described an example of achieving an off-set value for each wafer, for each chip pattern, and for each memory cell array, and sequentially correcting each defect coordinate. Achieving an off-set value for each wafer enables e.g. the correction of deviation of the coordinate system for each inspection over a plurality of surface inspection apparatuses. Achieving an off-set value for each chip pattern enables the correction of deviation of the coordinate system e.g. for each exposure shot of the stepper.

Furthermore, achieving an off-set value for each memory cell array enables e.g. the correction of measurement errors. For instance, the irradiation position of the electron beam in the SEM type surface inspection apparatus may be varied by electric charging. More specifically, if the components of the chip pattern are unevenly placed, their electric charging generates a potential distribution. This may deflect the electron beam and decrease the accuracy of defect coordinates. In the example shown in FIG. 12A, the defects detected successively in the Y-direction are arranged in a bent curve. In contrast, the corrected defects shown in FIG. 14B are arranged in a line extending in the Y-direction. This indicates that the positional accuracy of defects is improved.

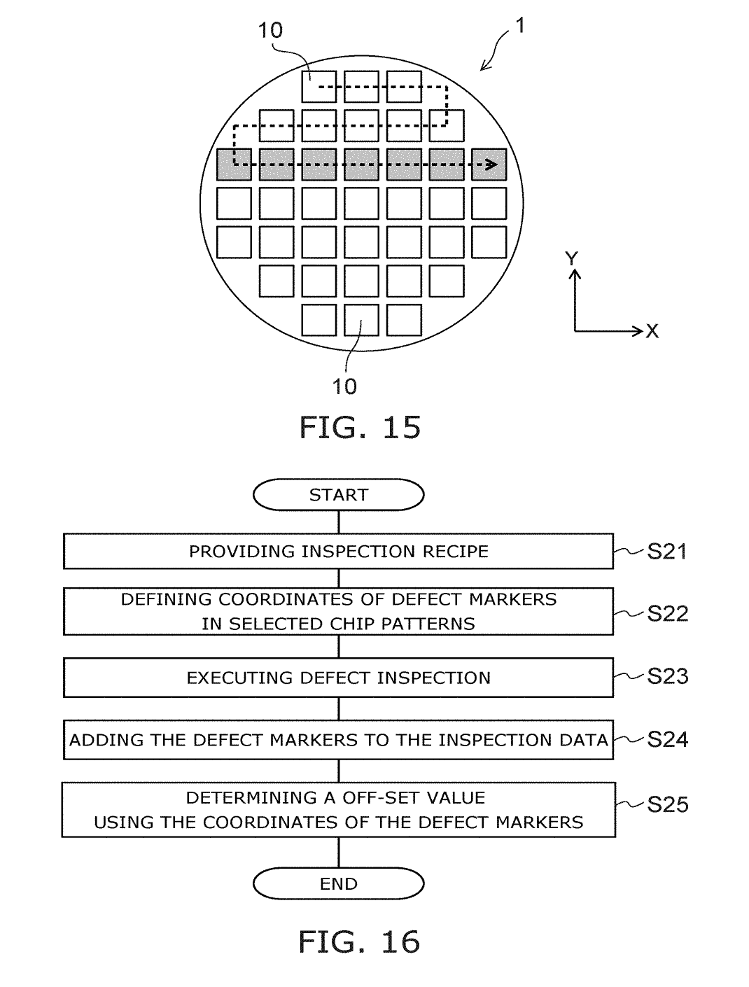

The embodiment is not limited to the above example. For instance, FIG. 15 shows a scan direction at the time of wafer inspection. As shown in FIG. 15, the embodiment may further include the step of achieving an off-set value for each group of chip patterns 10 arranged in the scan direction (e.g.

X-direction) at the time of wafer inspection.

### Third embodiment

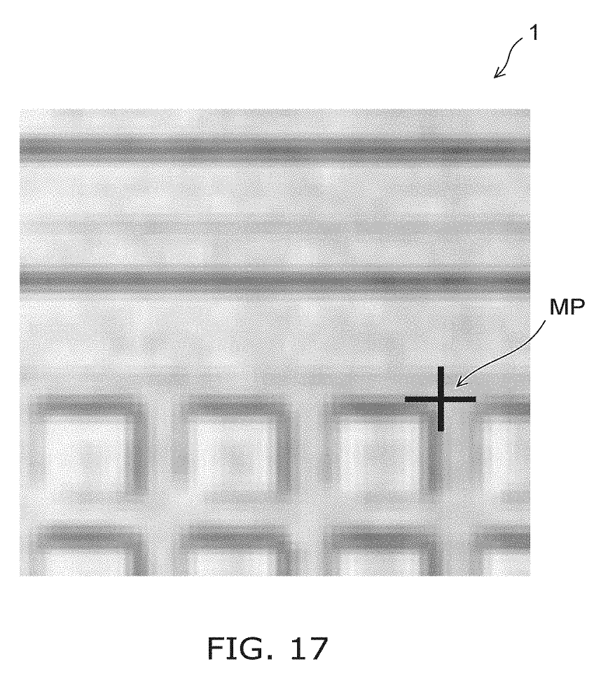

FIG. 16 is a flow chart showing a wafer inspection method according to a third embodiment. In this example, marker defects are added at prescribed positions in the selected chip patterns 10 without providing position markers 20 in the wafer 1. FIG. 17 is a schematic view showing an example of specifying coordinates MP for providing a marker defect in the chip pattern 10.

Step S21: Setting an inspection recipe. For instance, a wafer size, a repetition pitch of chip patterns 10 formed on a wafer and an arrangement thereof are set in this step.

Step S22: Setting positions (marker points) for adding marker defects. For instance, the chip patterns 10 for setting marker defects are selected from a plurality of chip patterns 10 arranged on the wafer. Then, the prescribed coordinates MP in the chip pattern 10 are assigned as a marker point. The marker point specified in the chip pattern 10 is preferably a portion that can be identified with high positional accuracy, such as a corner of the pattern as shown in FIG. 17, or a portion having a unique shape.

Step S23: Scanning the surface of the wafer 1 to detect surface defects. For instance, the SEM images, the bright-field images, or the dark-field images are compared in adjacent chip patterns 10. The presence or absence of defects is determined based on the difference of signal intensity exceeding a preset threshold, and the coordinates of each defect are recorded.

Step S24: Adding marker defects to the inspection data. The position corresponding to a marker point of the selected chip pattern 10 is identified using e.g. the SEM image. A defect serving as a marker (marker defect) is added at the coordinates of the position. In this case, the position of the marker defect is specified in the coordinate system of the inspection apparatus (hereinafter, the inspection coordinate system).

Step S25: Determining an off-set value using the coordinates of the marker defects. For instance, the difference between the coordinate of the marker defect specified by the inspection coordinate system and the coordinate MP of the marker point specified using the coordinate system on the wafer (hereinafter, the reference coordinate system) is achieved as an off-set value. Furthermore, the achieved off-set value is used to correct the coordinates of defects for each wafer. This may improve the accuracy of defect coordinates.

In the examples described above in the first to third embodiments, the positional accuracy of the defect coordinates is improved by the off-set value of defect coordinates which is achieved using the result of wafer inspection. Thus, the failure analysis may be performed using e.g. DBB (design-based binning), and improve the manufacturing yield of semiconductor devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A wafer inspection method for a manufacturing process of a semiconductor device, the method comprising:
providing a wafer with at least one position marker;
setting a care area around the at least one position marker;
detecting a plurality of defects in the wafer by using a surface inspection apparatus identifying the at least one position marker as a defect, the plurality of defects including the defect corresponding to the at least one position marker; and
achieving an off-set value of coordinates of the plurality of defects based on the coordinates of the defect corresponding to the at least one position marker and the coordinates of the at least one position marker.

2. The method according to claim 1, wherein the care area is set so as not to include a structural element other than the at least one position marker.

3. The method according to claim 1, wherein
the wafer includes a chip pattern on a surface provided with the at least one position marker, and
the at least one position marker is provided adjacent to the chip pattern.

4. The method according to claim 1, wherein
the wafer includes a chip pattern on a surface provided with the at least one position marker, and
the at least one position marker is provided in the chip pattern.

5. The method according to claim 4, wherein the care area includes no element constituting the chip pattern.

6. The method according to claim 1, wherein
the care area includes two or more position markers, and
coordinates of defects corresponding to the two or more position markers are detected based on a distance between the two or more position markers.

7. The method according to claim 6, wherein the distance between the two or more position markers is defined on a line passing through geometric barycenter of the two or more position markers.

8. The method according to claim 7, wherein
the care area includes four or more position markers, and
distances of the four or more position markers defined on a line passing through geometric barycenter of the four or more position markers are constant.

9. The method according to claim 1, wherein
a plurality of mask layers used in the manufacturing process of the semiconductor device include marker patterns corresponding to the at least one position marker respectively, and
the wafer includes position markers formed using the plurality of mask layers, the position markers being placed so as not to overlap each other in the care area.

10. The method according to claim 9, wherein
the plurality of mask layers include a positive-type marker pattern and a negative-type marker pattern, and
the wafer includes position markers formed by the positive-type marker pattern and the negative-type marker pattern.

11. The method according to claim 10, wherein the care area includes position markers formed by alternately using the positive-type marker pattern and the negative-type marker pattern.

12. The method according to claim 1, wherein the at least one position marker include a plurality of sub-patterns.

13. A wafer inspection method comprising:
setting a marker point on a wafer, a first coordinates of the marker point being assigned in a reference coordinate system on the wafer;
detecting surface defects of the wafer using a surface inspection apparatus;
adding a marker defect to the surface defects, the marker defect being set at a position of the marker point, and a second coordinates of the marker point being determined in an inspection coordinate system of the surface inspection apparatus; and
correcting coordinates of the surface defects based on the first coordinates and the second coordinates of the marker point.

14. The method according to claim 13, wherein
the wafer includes a chip pattern provided on a surface thereof, and
the marker point is set in the chip pattern.

15. A wafer inspection method comprising:
detecting defects of a plurality of wafers using a surface inspection apparatus;
selecting pairs of defects from the defects of the plurality of wafers, the pairs of defects each having a distance between one defect and the other defect, the distance lying in a prescribed range;
calculating a cumulative normal probability distribution of the distance in each of the plurality of wafers; and
extracting an off-set value of the defects for each of the plurality of wafers based on a median distance of the cumulative normal probability distribution.
